(19) United States
(12) Patent Application Publication
(10) Pub. No.: US 2003/0102176 A1
(43) Pub. Date: Jun. 5, 2003

(54) Vehicle with a stabilized tilting section

(76) Inventor: Eric Saqueton Bautista, Portland, OR (US)

Correspondence Address: ERIC S. BAUTISTA, 15020 NW SUMIDA LANE, PORTLAND, OR, 97229, US

(21) Appl. No.: 10/011,868

(22) Filed: Dec. 3, 2001

(51) Int. Cl. B62K 5/02; B60G 1/00

(52) U.S. Cl. 180/210; 280/124.103

(57) ABSTRACT

In accordance with the present invention a vehicle comprises a tilting section and a hanging section both connected to each other. When the vehicle is stationary or traveling straight, gravity will pull the hanging section downwards which will stabilize and keep the tilting section upright. When the vehicle is turning, centrifugal force will swing the hanging section outward and tilt the tilting section inside the turn.

### BACKGROUND OF INVENTION

1. Field of Invention

This invention relates to tilting vehicles.

2. Description of Prior Art

One of the reasons why motorcycles are more fun and more exciting to ride than cars is because they can tilt when negotiating a turn. Tilting eliminates the sideward pull of the centrifugal force on passengers since the interaction of gravity and centrifugal force leaves a net force parallel to the motorcycle. Tilting also makes motorcycles more resistant to rollovers and gives it greater cornering power as the tires are further pressed onto the ground. Motorcycles, however, are not as easy to drive as cars. They are not inherently stable and the operator has to keep it balanced when it is moving by properly shifting his or her weight and by properly steering the handlebar. Motorcycles are also not as safe as cars since they cannot be fully enclosed for the protection of the operator and passenger. This is because the operator needs to plant his/her feet on the ground to keep the motorcycle upright when it is stationary. Cars on the other hand are stable when stationary and when traveling under normal driving conditions and the operator only needs to control speed and direction to drive it.

Many have attempted to combine the safety, ease of use, and stability of an automobile with the leaning capability of a motorcycle. Past attempts either employed complex mechanisms or added unconventional controls for the operator to stabilize and control a tiltable vehicle. U.S. Pat. No. 4,088,199 by Trautwein describes a stabilized three-wheeled vehicle where the operator uses his/her legs to lean the vehicle to the side when turning. U.S. Pat. No. 4,351,410 by Townsend describes a self-balancing wheeled vehicle that can tilt when turning using hydraulic actuators connected to a device that senses the turn. U.S. Pat. No. 4,624,469 by Bourne Jr. describes a three-wheeled vehicle with controlled wheel and body lean that is tilted directly by the steering mechanism, which requires extra effort from the operator in turning the steering wheel. U.S. Pat. No. 5,927,424 by Van Den Brink et al. describes a tilting vehicle that uses power-assisted tilting elements, sensors, and steering input to tilt the passenger compartment of the vehicle. Even though these vehicles were able to combine the stability of a car and the tilting feature of a motorcycle, the addition of complex mechanisms and/or unconventional controls has not provided a simple, relatively safe, inexpensive, and easy to use solution.

Bright et al discussed a vehicle with a simple tilting mechanism in U.S. Pat. No. 4,072,325. The prior art uses a generalized pendulum to tilt the whole vehicle inside the turn. However, further analysis would show that the pendulum of the prior art is not hanging from the ground because of a wheel directly supporting the pendulum from the ground, which does not allow the pendulum to freely swing relative to the ground. Hence, the pendulum of the prior art is not really suspended and will not properly tilt the vehicle described in the prior art.

The present invention is a vehicle with a tilting section and a hanging section that acts like a pendulum. Unlike the pendulum of the prior art, the hanging section of the present invention is suspended and can freely swing relative to the ground. It is connected to the tilting section so that swinging of the hanging section to the outside when the vehicle is turning will cause leaning of the tilting section inside the turn, while downward orientation of the hanging section will stabilize the tilting section and keep it upright.

### SUMMARY

In accordance with the present invention a vehicle comprises a tilting section and a hanging section both connected to each other. When the vehicle is stationary or traveling straight, gravity will pull the hanging section downwards which will stabilize and keep the tilting section upright. When the vehicle is turning, centrifugal force will swing the hanging section outward and tilt the tilting section inside the turn.

Objects and Advantages

Accordingly it is the object of this invention to provide an improved vehicle that combines the stability, ease of use, and safety of a car and the tilting capability of a motorcycle for added excitement, comfort, and improved cornering.

A further object of this invention is to provide a vehicle that has a stabilized tilting section but, unlike the prior art, the tilting mechanism is simpler, hence less expensive, safer and more reliable, and does not require any additional nor unconventional controls for the driver to operate.

Further objects, features, and advantages of the present invention will become more apparent from the following description when taken in connection with the accompanying drawings, which show for purposes of illustration only, a preferred and alternative embodiments of the present invention.

### BRIEF DESCRIPTION OF THE DRAWINGS

FIG. 1 is an angled front view of the preferred embodiment

FIG. 2 is an angled rear view of the preferred embodiment

FIG. 3 is a side view of the preferred embodiment with a projected enclosure

FIG. 4 is a front view of the preferred embodiment when stationary or traveling in a straight path

FIG. 5 is a front view of the preferred embodiment when turning

FIG. 6 is an angled front view of the alternative embodiment in an upright position

FIG. 7 is an angled front view of the alternative embodiment tilted to one side

FIG. 8 is a four bar linkage arrangement

FIG. 9 is a suspending arc-shaped rail mount

### DETAILED DESCRIPTION OF INVENTION

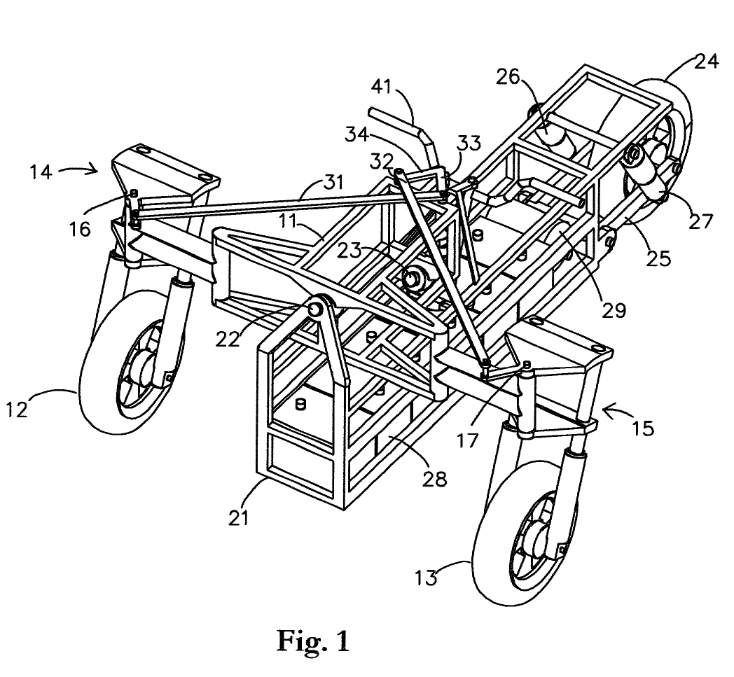

In FIG. 1 the preferred embodiment is shown with a chassis comprising a suspension frame 11 at the front and a pivoting frame 21 at the rear. Suspension frame 11 is supported from the ground by a pair of wheels 12 and 13. Wheels 12 and 13 are rotatably mounted on a pair of telescoping fork assemblies 14 and 15, and fork assemblies 14 and 15 are pivotally mounted on each side of a suspension frame 11 through two bolts 16 and 17, respectively. Pivotally mounted below and rearward of suspension frame 11 is pivoting frame 21 having seats on top (not shown) to also serve as passenger compartment. Pivoting frame 21 is pivotally attached to suspension frame 11 through two bolts 22 and 23 and is supported from the ground, at the rear, by a centrally positioned wheel 24. Rear wheel 24 is rotatably mounted on one end of a swingarm 25 while the other end of the swingarm 25 is rotatably mounted on pivoting frame 21 and resiliently supported by two shock absorbers 26 and 27 on each side. Within pivoting frame 21 is a battery pack 28 and a motor 29. Battery pack 28 located at the bottom of pivoting frame 21 contains energy for running motor 29, and motor 29 is coupled to rear wheel 24 through chains and sprockets (both not shown) to propel the vehicle.

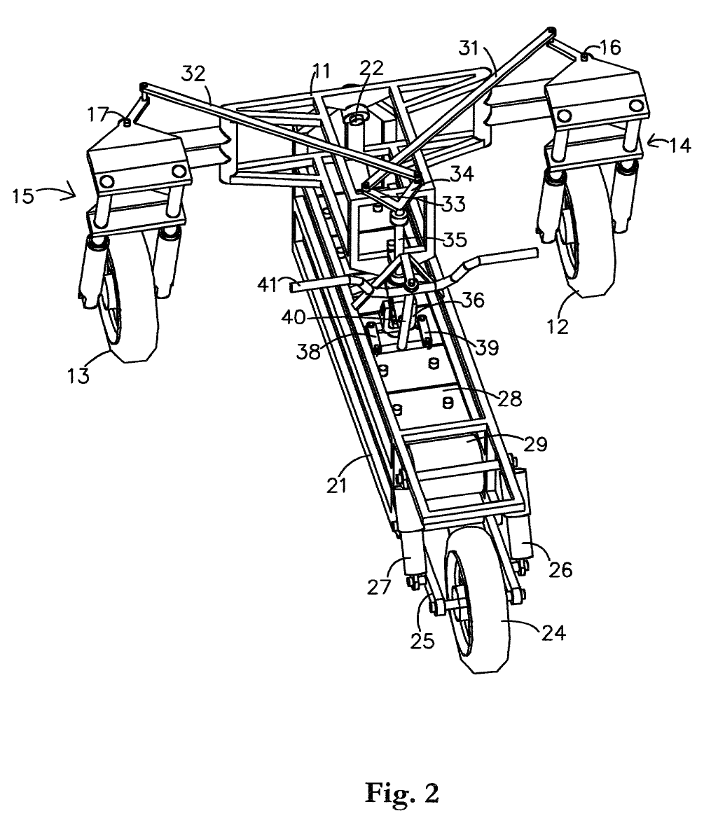

FIG. 2 is an angled rear view of the preferred embodiment showing the different linkages for steering the direction of wheels 12 and 13, indirectly mounted on suspension frame 11, using a control element, specifically a handlebar 41, mounted on pivoting frame 21. In FIG. 2, one end of a steering linkage 31 is pivotally connected to an arm at the top of fork assembly 14, on the right, and one end of a steering linkage 32 is pivotally connected to an arm at the top of fork assembly 15, on the left. The opposite ends of linkages 31 and 32 are pivotally connected to two perpendicular arms 33 and 34, respectively, which are rigidly attached to a steering shaft 35. Shaft 35 is rotatably mounted on suspension frame 11 and is fastened to the top part of a universal joint 36. The bottom part of universal joint 36 has arms on its sides and is kept in parallel with arms at the bottom of a handlebar shaft 40 through two parallel links 38 and 39. Both parallel links 38 and 39 are pivotally attached to the opposite arms at the bottom of universal joint 36 and arms at the bottom of handlebar shaft 40. Handlebar 41 is rigidly attached to handlebar shaft 40, and both are pivotally mounted on pivoting frame 21. Hence, the operator (not shown) of the vehicle can steer handlebar 41 and through the arrangement of shafts, links and u-joint simultaneously rotate fork assemblies 14 and 15 on which front wheels 12 and 13 are respectively mounted.

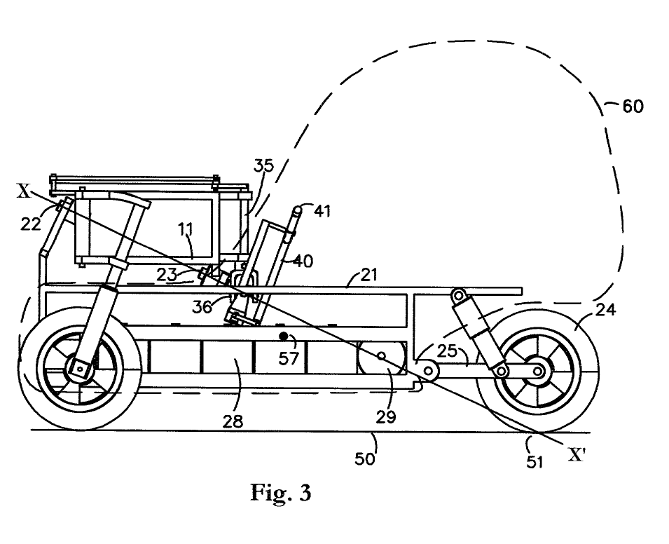

FIG. 3 shows the actual pivot axis of pivoting frame 21 relative to suspension frame 11 as denoted by X-X′. Pivot axis X-X′ projects rearward and downward along the longitudinal axis of pivoting frame 21, through bolts 22 and 23, and through the ground support area 51 of rear wheel 24 and the ground 50. The intersection of the axes of universal joint 36 also lies along pivot axis X-X′ to maintain the coupling between steering shaft 35, which is mounted on suspension frame 11, and the linkages and shafts leading to handlebar 41, which is mounted of pivoting frame 21. Especially, whenever pivoting frame 21 is pivoted relative to suspension frame 11. Pivot axis X-X′ passes through ground support area 51 between rear wheel 24 and the ground 50 so that pivoting frame 21 can freely pivot relative to suspension frame 11 and relative to the ground 50. Thus, pivot axis X-X′ is the effective pivot axis of pivoting frame 21 relative to the ground. Suspension frame 11 and ground 50 hangs and allows the swinging of the section below axis X-X′ of pivoting frame 21 and allows the tilting of the section above axis X-X′ of pivoting frame 21 relative to the ground.

FIG. 3 also shows the laden center of gravity 57 of pivoting frame 21, which takes into consideration the weight of passengers (not shown) and components mounted on pivoting frame 21. Since battery pack 28 is mounted at the bottom part of pivoting frame 21 and since it is heavier compared to the other components mounted on pivoting frame 21, including the passengers, the laden center of gravity 57 of pivoting frame 21 is below pivot axis X-X′.

A possible enclosure 60 for pivoting frame 21 is also projected in FIG. 3. It will protect the passengers (not shown) from the elements and prevent them from falling out of the vehicle.

Operation

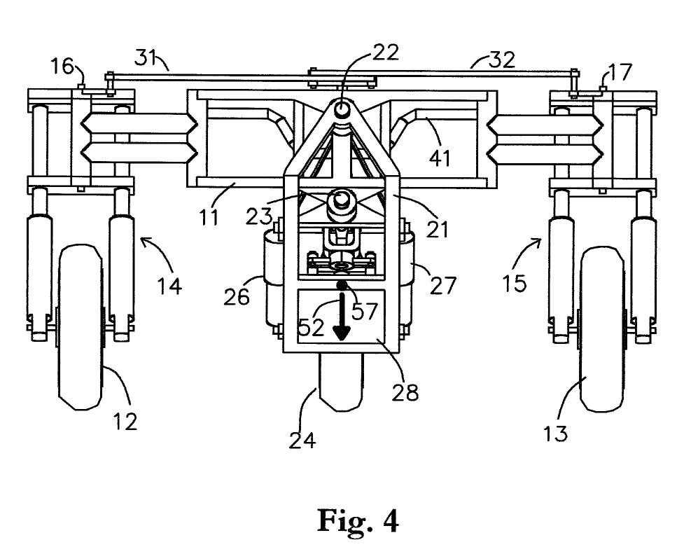

FIG. 4 shows the front view of the preferred embodiment when it is stationary or traveling in a straight path. In FIG. 4, center of gravity 57 is being pulled downward and kept at its lowest point directly below pivot axis X-X′, through bolt 22, by a gravitational force 52. Any sideward and upward shifting of center of gravity 57 due to the normal shifting of weight of passengers or due to other external forces such as the wind will cause gravitational force 52 to pull center of gravity 57 back to its lowest point directly below bolt 22. Once center of gravity 57 is directly below pivot axis X-X′, through bolt 22, gravitational force 52 can no longer pull it further down and will just keep center of gravity 57 in that position until center of gravity 57 shifts again. Hence gravitational force 52 stabilizes pivoting frame 21 by keeping center of gravity 57 directly below pivot axis X-X′ thereby keeping pivoting frame 21 upright.

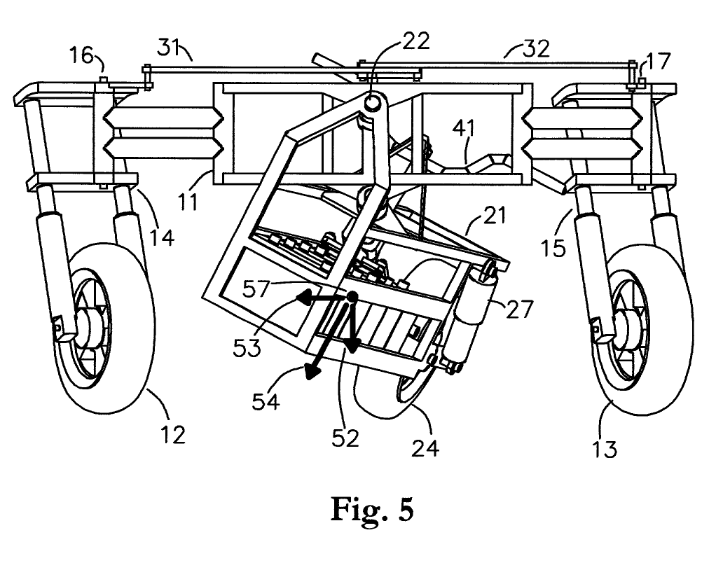

FIG. 5 shows the front view of the preferred embodiment when it is turning or traveling in a curved path. In FIG. 5, a centrifugal force 53, directed outward of the turn, will act on center of gravity 57 which will cause center of gravity 57 to swing outward of the turn and upward relative to suspension frame 11 thereby tilting pivoting frame 21 into the turn. While centrifugal force 53 is raising center of gravity 57 higher from the ground it will be opposed by gravitational force 52, also acting on center of gravity 57, pulling center of gravity 57 downward. Once the two forces 53 and 52 reach equilibrium, the inclination of pivoting frame 21 will be maintained at a certain angle during the turn. Changes in the slope of the road will automatically adjust the tilt of pivoting frame 21 by changing the directions of centrifugal force 53 and gravitational force 52 as they act on center of gravity 57, and will adjust the inclination to the proper angle until they both reach equilibrium. With pivoting frame 21 properly tilted during turns, the effect of both centrifugal force 53 and gravitational force 52 on the passengers (not shown) will be a downward diagonal net force 54 parallel to pivoting frame 21 that presses the passengers (not shown) towards their seats (not shown). This is a lot more comfortable than the sideward force passengers encounter in a non-tilting vehicle such as a car when it is turning. Also, the effect of net force 54 on rear wheel 24 will be to press it further against the ground and give it more traction.

Alternative Embodiment

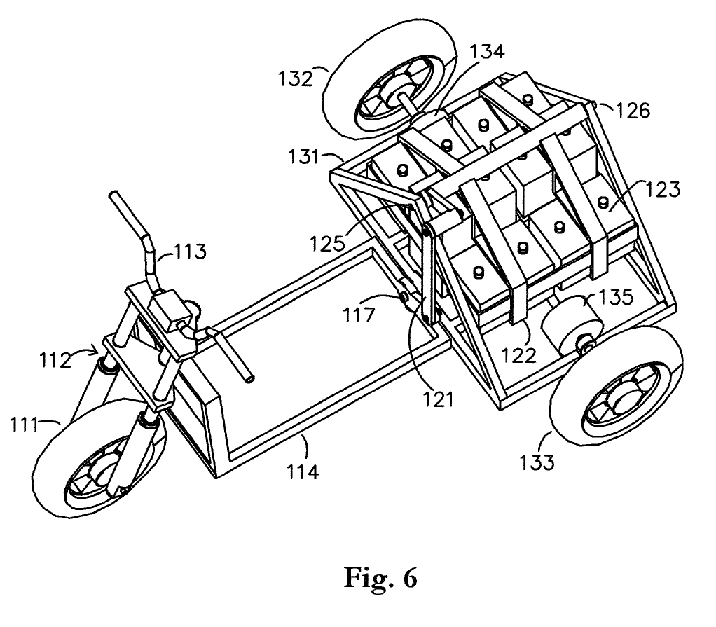

In FIG. 6 an alternative embodiment of the present invention is shown with a chassis structure made up of three connected frames: a tilting frame 114, a hanging frame 122, and a suspension frame 131. At the front is tilting frame 114 supported by a wheel 111, which is rotatably mounted on a telescoping fork assembly 112. Mounted on top of fork assembly 112 is a handlebar 113 for controlling steering. Fork assembly 112 is then rotatably mounted on tilting frame 114. Tilting frame 114 has seats (not shown) mounted on top to also serve as a passenger compartment and is pivotally supported by suspension frame 131 through a bolt 117. Mounted on suspension frame 131 are two rear wheels 132 and 133, and two motors 134 and 135. Hanging frame 122 is pivotally mounted on suspension frame 131 through two bolts 125 and 126 which suspend and allow hanging frame 122 to laterally swing relative to suspension frame 131 and relative to the ground. Mounted within hanging frame 122 is a battery pack 123, and battery pack 123 is connected to motors 134 and 135 through flexible wires (not shown) to power them. Hanging frame 122 is then connected to tilting frame 114 through a linkage 121 that is pivotally attached to both frames.

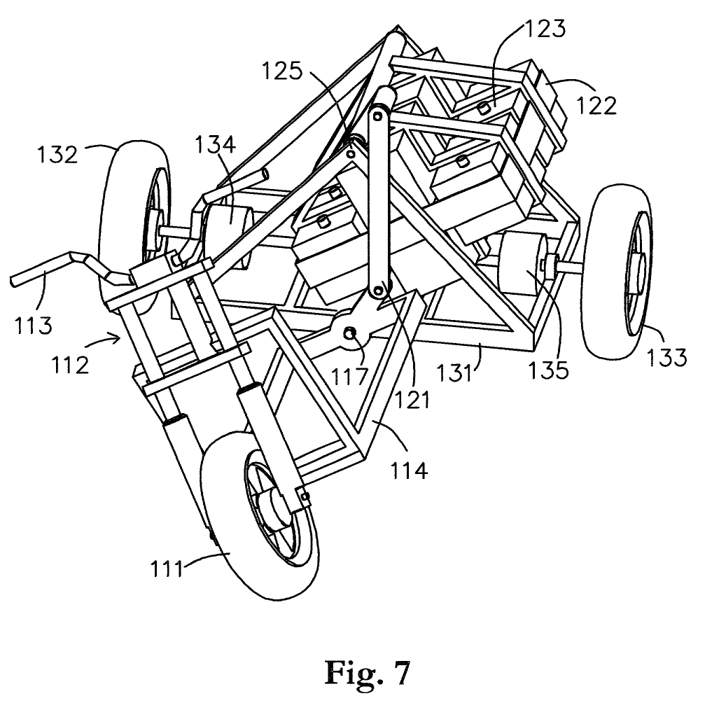

Tilting frame 114 of the alternative embodiment in FIG. 6 tilts and is stabilized similarly to the section above pivot axis X-X′ of pivoting frame 21 of the preferred embodiment in FIG. 3. Hanging frame 122, on the other hand, is similarly suspended like the section below pivot axis X-X′ of pivoting frame 21 of the preferred embodiment in FIG. 3. Similar to the positioning of the center of gravity 57 below pivot axis X-X′ of the preferred embodiment in FIG. 3, which implies that the section below pivot axis X-X′ is heavier than the section above pivot axis X-X′ of pivoting frame 21, the laden moment of inertia of hanging frame 122 which includes its mounted components in FIG. 6 is greater than the laden moment of inertia of tilting frame 114 which includes its mounted components and the weight of the passengers (not shown). Moment of inertia is the effective quantity of mass or inertia of a body relative to an axis of rotation, and the heavy battery pack 123 mounted within hanging frame 122 adds a considerable mass to hanging frame 122 to overpower the reaction of tilting frame 114 from external forces and will determine both their orientation. Hence, whenever the alternative embodiment is stationary or traveling in straight path, hanging frame 122 will act like a pendulum and hang downwardly and keep tilting frame 114 stabilized and upright as shown in FIG. 6, and whenever the alternative embodiment is making a turn, hanging frame 122 will swing to the outside of the turn and tilt tilting frame 114, through linkage 121, inside the turn as shown in FIG. 7.

Conclusion, Ramifications and Scope

Thus, the descriptions above provide a vehicle that is stable, safe, and has a stabilized tilting section without the complex mechanisms and the additional or unconventional operator controls of the prior art. The tilting and stabilization process of the present invention is automatically accomplished by gravitational and centrifugal forces acting on a hanging section in the vehicle, which acts like a pendulum, and is a lot simpler compared to the complex mechanisms of the prior art. Unlike the pendulum tilting mechanism of one prior art, the hanging section of the present invention is free to swing relative to the ground and so will react quickly and accordingly to gravity and centrifugal force to properly stabilize or tilt the tilting section of the vehicle.

The vehicles described above also perform better cornering compared to a car and safer cornering compared to a motorcycle. When a regular car is doing a high-speed turn, most of its weight is concentrated at the front wheel located on the outside of the turn. In the present invention, the single rear wheel 24 of the preferred embodiment in FIG. 5 and the single front wheel 111 of the alternative embodiment in FIG. 7 will bear a significant portion of the weight of the vehicle and will have improved traction during turns since the combination of the gravitational and centrifugal force will be directed downward and perpendicular to their treads. The three wheels of the two embodiments of the present invention will also make them more resistant to slippage compared to the two wheels of motorcycles, especially during wet weather.

While the above descriptions contain a preferred and an alternative embodiment, these should not be construed as limitations on the scope of the invention but rather as exemplification of the possible embodiments of the present invention of which many other variations are possible. The present invention can have a four-wheel configuration in which all the wheels are mounted on a suspension structure and a pivoting structure can be hung onto the suspension structure to act like a pendulum. The present invention can also have two suspension structures both supporting a pivoting structure and each suspension structure having two wheels.

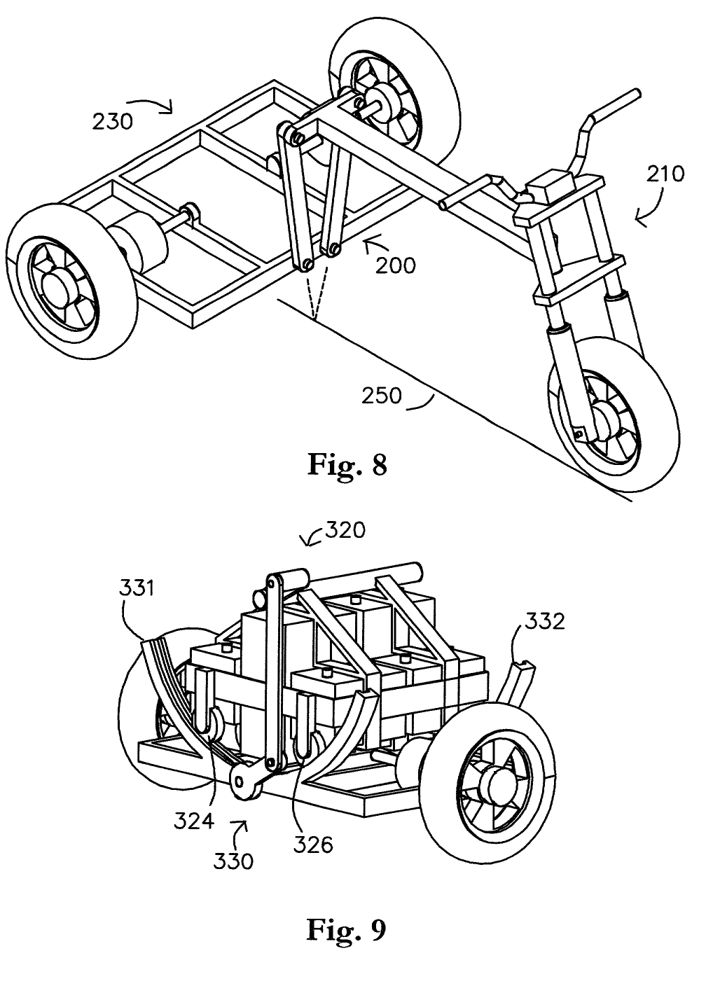

The elements of the present invention are also not just limited to the ones described above. For example, the present invention is not just limited to an electric motor and battery as powertrain. The present invention, such as through the preferred embodiment in FIG. 1, can also be driven by an internal combustion engine running on liquid fuel or other kinds of powertrains as long as the resulting pivoting frame 21 and mounted components have an effective pivot axis that projects above their center of gravity 57 and passes through ground support area 51 as shown in FIG. 3. The pivotal connections between the suspension structure and the mounted structures of the present invention can also employ arrangements other than a simple bolt connection such as hinges, journals, bearings etc. A four-bar linkage arrangement 200 shown in FIG. 8, between a tilting structure 210 and a suspension structure 230, can be used to place the effective tilt axis 250 of tilting structure 210 at a virtual location, which in this case is at ground level. The four-bar linkage 200 in FIG. 8 when turned upside down can also be used as a way to hang or suspend a structure from another structure. Another arrangement that would allow pivoting frame 21 of the preferred embodiment in FIG. 1 and the hanging frame 122 of the alternative embodiment in FIG. 6 to swing sideways and be suspended is shown in FIG. 9. FIG. 9 shows a hanging structure 320 mounted with rollers 324 and 326 on arc-shaped rails 331 and 332, which are part of a suspension structure 330, so that hanging structure 320 is suspended and can swing laterally by simultaneously rolling sideward and upward.

Aside from the above ramifications, mechanical dampeners can also be placed between the different pivotal connections to smoothen any sudden motion to make the ride more comfortable and safer to the passengers. Also, the coupling between hanging frame 122 and tilting frame 114 in FIG. 6 is not just limited to simple linkage 121. The connection can make use of chains and sprockets, belts, pulleys, gears, and other rotary transmission devices. Lastly, other devices can also be used to provide flexible coupling between the steering components in suspension frame 11 and the steering components in pivoting frame 21 in FIG. 1, other than the use of linkages, shafts, and universal joints. To provide flexible coupling combinations of flexible shafts, chains, sprockets, belts, pulleys and gears can also be used.

I claim:

1. A self propelled vehicle comprising a chassis structure, at least three ground engaging wheels mounted on said chassis structure, at least one of said wheels is directionally controllable, powertrain means mounted on said chassis structure and coupled to at least one of said wheels, braking means mounted on said chassis structure and coupled to at least one of said wheels, and a control element rotatably mounted on said chassis structure and coupled to said at least one directionally controllable wheel, wherein said chassis structure comprises at least one suspension structure, each suspension structure has at least two of said wheels mounted thereunder and at least one pair of the mounted wheels are positioned side by side to provide lateral stability, a pivoting structure with room for at least one passenger, and at least one pivotal means for mounting said pivoting structure to at least one of said suspension structures such that the effective pivot axis of said pivoting structure relative to the ground is along its longitudinal axis and projects above its laden center of gravity thereby hanging at least a section of said pivoting structure from the ground whereby gravity will urge said center of gravity downwards and will maintain said pivoting structure in a substantially upright position whenever the vehicle is stationary or traveling in a straight path and centrifugal force will urge said center of gravity outward of the turn and tilt said pivoting structure inside the turn whenever the vehicle is turning.

2. The vehicle of claim 1 wherein said pivoting structure has one of said wheels rotatably mounted thereunder to provide ground support and said effective pivot axis of said pivoting structure is angled downward and passes through the ground support area whereby the mounted wheel will pivot with said pivoting structure to maintain ground support while allowing said pivoting structure to pivot freely relative to said at least one suspension structure and relative to the ground.

3. The vehicle of claim 1 wherein said powertrain means comprises at least one electric motor and at least one battery, and said at least one battery is mounted at the bottom part of said pivoting structure to position its laden center of gravity closer to the ground.

4. The vehicle of claim 1 wherein said chassis structure is enclosed for the protection and comfort of the passengers.

5. The vehicle of claim 1 further comprising at least one dampening means between one suspension structure and said pivoting structure so as to smoothen or prevent sudden pivoting of said pivoting structure relative to the dampened suspension structure.

6. The vehicle of claim 1 wherein said at least one pivotal means for mounting said pivoting structure to at least one of said suspension structures is a combination of members selected from the group consisting of hinges, linkages, shafts, bearings, journals, and bolts.

7. The vehicle of claim 1 wherein said at least one pivotal means for mounting said pivoting structure to at least one of said suspension structures is a sliding or rolling mount with an arc-shaped rail or guide.

8. The vehicle of claim 1 wherein said at least one directionally controllable wheel is mounted on one of the suspension structures on which said pivoting structure is pivotally mounted and said control element is rotatably mounted on said pivoting structure, and coupling between said at least one directionally controllable wheel and said control element is flexible, such that coupling is maintained whenever said pivoting structure pivots relative to said suspension structure.

9. The vehicle of claim 8 wherein the flexible coupling between said control element and said at least one directionally controllable wheel is a combination of members selected from the group consisting of linkages, universal joints, shafts, gears, chains, sprockets, and flexible shafts.

10. A self propelled vehicle comprising a chassis structure, at least three ground engaging wheels mounted on said chassis structure, at least one of said wheels is directionally controllable, powertrain means mounted on said chassis structure and coupled to at least one of said wheels, braking means mounted on said chassis structure and coupled to at least one of said wheels, and a control element rotatably mounted on said chassis structure and coupled to said at least one directionally controllable wheel, wherein said chassis structure comprises at least one suspension structure, at least two of said wheels are mounted on each suspension structure and at least one pair of the mounted wheels on each suspension structure is mounted side by side to provide lateral stability, a tilting structure having room for at least one passenger, at least one tilting means for mounting said tilting structure to at least one of said suspension structures giving said tilting structure an effective tilt axis that is along its longitudinal axis, a hanging structure having a laden moment of inertia that is greater than the laden moment of inertia of said tilting structure with each structure's laden moment of inertia being relative to each structure's effective pivot axis, at least one hanging means for mounting said hanging structure to at least one of said suspension structures such that said hanging structure is suspended from the ground and can laterally swing relative to the ground, and means for connecting said tilting structure to said hanging structure whereby gravity will urge said hanging structure downwards which will keep said tilting structure in a substantially upright orientation whenever the vehicle is stationary or traveling in a straight path and centrifugal force will urge said hanging structure outward of the turn which will tilt said tilting structure inside the turn whenever the vehicle is turning.

11. The vehicle of claim 10 wherein said powertrain means comprises at least one battery and at least one electric motor and said at least one battery is mounted on said hanging structure to add to said hanging structure's laden moment of inertia.

12. The vehicle of claim 10 wherein said tilting structure has one of said wheels rotatably mounted thereunder to provide ground support whereby the mounted wheel will tilt with said tilting structure to maintain ground support whenever said tilting structure tilts relative to the ground.

13. The vehicle of claim 12 wherein said effective tilt axis of said tilting structure is angled downward and passes through the ground support area allowing said tilting structure to tilt freely relative to said at least one suspension structure and relative to the ground.

14. The vehicle of claim 10 wherein said chassis structure is enclosed for the protection and comfort of the passengers.

15. The vehicle of claim 10 further comprising at least one dampening means between one of said suspension structures and said tilting structure so as to smoothen or prevent sudden tilting of said tilting structure relative to the dampened suspension structure.

16. The vehicle of claim 10 wherein said at least one tilting means for mounting said tilting structure to at least one of said suspension structures is a combination of members selected from the group consisting of hinges, linkages, shafts, bearings, journals, and bolts.

17. The vehicle of claim 10 further comprising at least one dampening means between one of said suspension structures and said hanging structure so as to smoothen or prevent sudden swinging of said hanging structure relative to the dampened suspension structure.

18. The vehicle of claim 10 wherein said at least one hanging means for mounting said hanging structure to at least one of said suspension structures is a combination of members selected from the group consisting of hinges, linkages, shafts, bearings, journals, and bolts.

19. The vehicle of claim 10 wherein said at least one hanging means for mounting said hanging structure to at least one of said suspension structures is a sliding or rolling mount with an arc-shaped rail or guide.

20. The vehicle of claim 10 wherein said means for connecting said tilting structure to said hanging structure is a combination of members selected from the group consisting of linkages, shafts, gears, belts, pulleys, chains, and sprockets.

21. The vehicle of claim 10 wherein said at least one directionally controllable wheel is mounted on one of the suspension structures on which said tilting structure is mounted and said control element is rotatably mounted on said tilting structure, and coupling between said at least one directionally controllable wheel and said control element is flexible, to maintain coupling whenever said tilting structure tilts relative to said suspension structure.

22. The vehicle of claim 21 wherein the flexible coupling between said control element and said at least one directionally controllable wheel is a combination of members selected from the group consisting of linkages, universal joints, shafts, gears, chains, sprockets, and flexible shafts.

23. A self propelled vehicle having room for at least one passenger, powertrain means, braking means, steering means, and at least three ground engaging wheels, wherein the improvement being at least one section of the vehicle can laterally tilt relative to the ground and at least one other section of the vehicle is hanging from the ground and can laterally swing relative to the ground, at least one of the hanging sections of the vehicle is connected to at least one of the tilting sections of the vehicle, and the total moment of inertia of the connected hanging sections is greater than the total moment of inertia of the connected tilting sections with each sections' moment of inertia being relative to each section's effective axis of rotation whereby swinging of the connected hanging sections on one side causes tilting of the connected tilting sections on the other side whenever the vehicle is turning and downward orientation of the connected hanging sections keep the connected tilting sections substantially upright whenever the vehicle is stationary or traveling in a straight path.
